(19) United States
(12) Patent Application Publication
(10) Pub. No.: US 2021/0015074 A1
(43) Pub. Date: Jan. 21, 2021

(54) ANIMAL CAGE AND METHOD

(71) Applicant: Abigail H. Wagner, York, PA (US)

(72) Inventor: Abigail H. Wagner, York, PA (US)

(21) Appl. No.: 16/931,715

(22) Filed: Jul. 17, 2020

Related U.S. Application Data
(60) Provisional application No. 62/875,710, filed on Jul. 18, 2019.

(51) Int. Cl. A01K 1/03; A01K 1/015; A01K 1/00; G06Q 30/06; G06Q 20/32; G06Q 20/34

(52) U.S. Cl. CPC A01K 1/03; A01K 1/0157; G06Q 20/34; G06Q 30/0645; G06Q 20/3278; A01K 1/0047

(57) ABSTRACT

A method of temporary storage of a domesticated animal can include providing a space defined by a door and top, bottom, side, and back surfaces, wherein the door is configured to be opened based on identification based on a payment method. An animal cage can include at least one top wall, at least one bottom wall, at least one back wall, at least two side walls, and a door, wherein the door is hingedly attached to at least one of the at least one top surface, at least one bottom surface, one of the at least two side surfaces, and wherein the door is configured to be opened based on identification based on a payment method.

This application claims priority to U.S. Provisional Application No. 62/875,710, titled “ANIMAL CAGE AND METHOD,” filed on Jul. 18, 2019, the entire contents of which is incorporated herein by reference.

### BACKGROUND

The subject disclosure generally relates to an animal cage and method of temporary storage of a domesticated animal, and in particular to utilizing an animal cage based on a payment method.

### SUMMARY

Provided is a method of temporary storage of a domesticated animal. The method can include providing a space defined by a door and top, bottom, side, and back surfaces, wherein the door is configured to be opened based on identification based on a payment method.

Also provided is an animal cage. The animal cage can include at least one top wall, at least one bottom wall, at least one back wall, at least two side walls, and a door, wherein the door is hingedly attached to at least one of the at least one top surface, at least one bottom surface, one of the at least two side surfaces, and wherein the door is configured to be opened based on identification based on a payment method.

### BRIEF DESCRIPTION OF FIGURES

FIG. 1 is a non-limiting example of an animal cage in accordance with one or more embodiments described herein.

### DETAILED DESCRIPTION

In an embodiment, provided is a method of temporary storage of a domesticated animal, comprising providing a space defined by a door and top, bottom, side, and back surfaces, wherein the door is configured to be opened based on identification based on a payment method. The payment method can include radio-frequency identification, near field communication, a magnetic strip, a bar code, a QR code, profile containing or utilizing the same, or combinations thereof. The payment method can transmit payment. The payment method can transmit unique, identifying information, such as a unique QR code, unique bar code, or unique information based on radio-frequency identification, near field communication, a magnetic strip, profile containing or utilizing the same, or combinations thereof. The identifying information can be information, including digital information, received during payment.

According to certain embodiments, the door is hingedly attached to at least one of the top, bottom, side, and back surfaces. The surfaces can comprise, consist essentially of, or consist of any of wood, metal, natural or synthetic polymers, natural or synthetic rubber, fiber-reinforced polymers or rubber. In some embodiments, the walls can comprise or consist of a fiber-reinforced material, such as a polymer or rubber, wherein the fibers are anti-microbial. The fibers can be, without limitation, silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony. According to certain embodiments, the space can include at least one removable pad, wherein the removable pad comprises an absorbent acrylic acid derivative. In some embodiments, the space can include a plurality of removable pads on an inner portion of the bottom surface, wherein the pads are removably bound to one another with an adhesive, thereby enabling removal of an individual pad after use.

In some embodiments, based on receipt of payment from the payment method, access can be provided to the space for the temporary storage of a domestic animal. Based on storage of the domestic animal, the door can be shut and automatically, electronically locked. The animal can be removed based on receipt of the identical identifying information, which can come from a unique QR code, unique bar code, or unique information based on radio-frequency identification, near field communication, a magnetic strip, profile containing or utilizing the same, or combinations thereof.

In some embodiments, the door, top, bottom, side, and back surfaces form a substantially rectangular cuboid. In some embodiments, the animal cage is configured to be fit adjacent to a similar animal cage, which can be a substantially rectangular cuboid. The animal cage can be configured to fit adjacent to a similar animal cage by an attachment portion. The attachment portion can be, for example, hook and loop fasteners, or friction fit with a coordinated groove and protrusion.

In some embodiments, the space comprises a hygienic coating. The hygienic coating can be a porous coating on an inner surface of the walls. The hygienic coating can be a paint comprising a quaternary ammonium compound, such as alkyl dimethyl benzyl ammonium chloride. In some embodiments, the hygenic coating can be a porous paint comprising a quaternary ammonium compound, such as alkyl dimethyl benzyl ammonium chloride. The hygienic coating can comprise, consist essentially of, or consist of a paint comprising a quaternary ammonium compound, such as alkyl dimethyl benzyl ammonium chloride, anti-microbial fibers, such as silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony, and anti-microbial foil, such as foils comprising, consisting essentially of, or consisting of copper, silver, zinc, antimony, and combinations thereof. In some embodiments, a hygienic coating can include multiple layers, wherein the layers comprise, consist essentially of, or consist of paint comprising a quaternary ammonium compound, such as alkyl dimethyl benzyl ammonium chloride, anti-microbial fibers, such as silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony, and anti-microbial foil, such as foils comprising, consisting essentially of, or consisting of copper, silver, zinc, antimony, and combinations thereof.

According to certain embodiments, the animal cage comprises a temperature sensor. The temperature sensor can be operatively coupled to an air temperature control system. In some embodiments, the temperature sensor can be embedded in at least one of the walls. In some embodiments, the temperature sensor can be attached to an inner surface of at least one of the walls. In some embodiments, the temperature sensor can be a thermocouple.

Also provided is an animal cage, comprising at least one top wall; at least one bottom wall; at least one back wall; at least two side walls; and a door, wherein the door is hingedly attached to at least one of the at least one top surface, at least one bottom surface, one of the at least two side surfaces, and wherein the door is configured to be opened based on identification based on a payment method. The walls can comprise, consist essentially of, or consist of any of wood, metal, natural or synthetic polymers, natural or synthetic rubber, fiber-reinforced polymers or rubber. In some embodiments, the walls can comprise or consist of a fiber-reinforced material, such as a polymer or rubber, wherein the fibers are anti-microbial. The fibers can be, without limitation, silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony. The payment method can include radio-frequency identification, near field communication, a magnetic strip, a bar code, a QR code, profile containing or utilizing the same, or combinations thereof. The payment method can transmit payment. The payment method can transmit unique, identifying information, such as a unique QR code, unique bar code, or unique information based on radio-frequency identification, near field communication, a magnetic strip, profile containing or utilizing the same, or combinations thereof In some embodiments, based on receipt of payment from the payment method, access can be provided to the animal cage for the temporary storage of a domestic animal. Based on storage of the domestic animal, the door can be shut and automatically, electronically locked by utilizing, for example, a bolt lock that turns to enclose a door upon receipt of an electronic signal based on receipt of the payment method. The animal can be removed based on receipt of the identical identifying information, which can come from a unique QR code, unique bar code, or unique information based on radio-frequency identification, near field communication, a magnetic strip, profile containing or utilizing the same, or combinations thereof. According to certain embodiments, the door is hingedly attached to at least one of the top, bottom, side, and back walls.

According to certain embodiments, the animal cage can include at least one removable pad, wherein the removable pad comprises an absorbent acrylic acid derivative. In some embodiments, the space can include a plurality of removable pads on an inner portion of the bottom surface, wherein the pads are removably bound to one another with an adhesive, thereby enabling removal of an individual pad after use.

In some embodiments, the door is configured to be locked based on a payment from the payment method. Based on receipt of a payment method, a locking mechanism, such as a bolt lock configured to lock based on receipt of an electronic signal, can toggle its position between open / unlocked and closed/locked. The payment method can include radio-frequency identification, near field communication, a magnetic strip, a bar code, a QR code, profile containing or utilizing the same, or combinations thereof. The payment method can transmit payment. The payment method can transmit unique, identifying information, such as a unique QR code, unique bar code, or unique information based on radio-frequency identification, near field communication, a magnetic strip, profile containing or utilizing the same, or combinations thereof. The unique information can correspond to a unique number. According to certain embodiments, the at least one top wall, at least one bottom wall, at least one back wall, and at least two side walls define a space therebetween. In some embodiments, the door is configured to provide access to the space for removal of the domesticated animal based on identification, wherein the identification is based on the payment method.

According to certain embodiments, the at least one top wall, at least one bottom wall, at least one back wall, at least two side walls, and door form a substantially rectangular cuboid, wherein the substantially rectangular cuboid is configured to be fit adjacent to a similar substantially rectangular cuboid. In some embodiments, the door, top, bottom, side, and back surfaces form a substantially rectangular cuboid. In some embodiments, the animal cage is configured to be fit adjacent to a similar animal cage, which can be a substantially rectangular cuboid. The animal cage can be configured to fit adjacent to a similar animal cage by an attachment portion. The attachment portion can be, for example, hook and loop fasteners, or friction fit with a coordinated groove and protrusion.

In some embodiments, the at least one top wall, at least one bottom wall, at least one back wall, at least two side walls, and door substantially enclose a space, wherein the space comprises a hygienic coating. The hygienic coating can be a porous coating on an inner surface of the walls. The hygienic coating can be a paint comprising a quaternary ammonium compound, such as alkyl dimethyl benzyl ammonium chloride. In some embodiments, the hygenic coating can be a porous paint comprising a quaternary ammonium compound, such as alkyl dimethyl benzyl ammonium chloride. The hygienic coating can comprise, consist essentially of, or consist of a paint comprising a quaternary ammonium compound, such as alkyl dimethyl benzyl ammonium chloride, anti-microbial fibers, such as silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony, and anti-microbial foil, such as foils comprising, consisting essentially of, or consisting of copper, silver, zinc, antimony, and combinations thereof In some embodiments, a hygienic coating can include multiple layers, wherein the layers comprise, consist essentially of, or consist of paint comprising a quaternary ammonium compound, such as alkyl dimethyl benzyl ammonium chloride, anti-microbial fibers, such as silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony, and anti-microbial foil, such as foils comprising, consisting essentially of, or consisting of copper, silver, zinc, antimony, and combinations thereof.

According to certain embodiments, the at least one top wall, at least one bottom wall, at least one back wall, at least two side walls, and door substantially enclose a space, wherein the space comprises at least one temperature sensor, wherein the temperature sensor is operatively coupled to an air temperature control system. The temperature sensor can be operatively coupled to an air temperature control system. In some embodiments, the temperature sensor can be embedded in at least one of the walls. In some embodiments, the temperature sensor can be attached to an inner surface of at least one of the walls. In some embodiments, the temperature sensor can be a thermocouple.

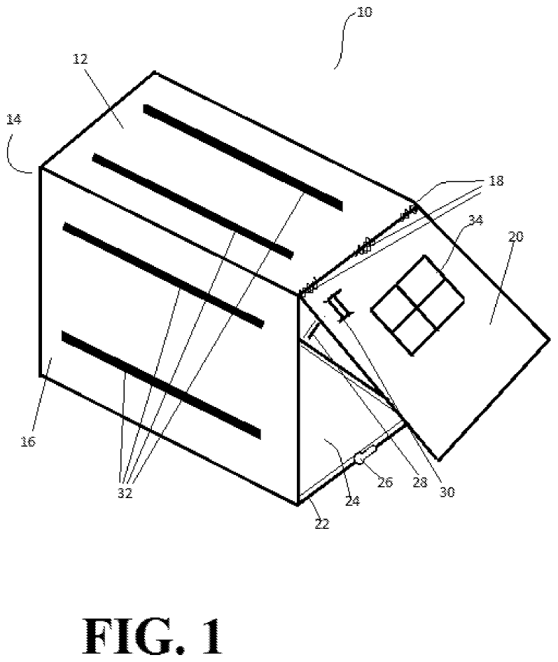

FIG. 1 is a non-limiting example of an animal cage 10 in accordance with one or more embodiments described herein. Shown is an animal cage 10, comprising: at least one top wall 12; at least one bottom wall 22; at least one back wall 14; at least two side wall 16s; and a door 20, wherein the door 20 is hingedly attached to at least one of the at least one top surface, at least one bottom surface, one of the at least two side surfaces, and wherein the door 20 is configured to be opened based on identification based on a payment method. The walls (12, 14, 16) and door 20 can comprise, consist essentially of, or consist of any of wood, metal, natural or synthetic polymers, natural or synthetic rubber, fiber-reinforced polymers or rubber. In some embodiments, the walls can comprise or consist of a fiber-reinforced material, such as a polymer or rubber, wherein the fibers are anti-microbial. The door 20 can include a window or vent 34, and be hingedly attached with hinges 18. The fibers can be, without limitation, silver fibers, silver oxide fibers, zinc fibers, antimony fibers, zinc oxide fibers, antimony oxide fibers, copper fibers, copper oxide fibers, and/or natural fibers, such as cellulose or cotton, that have been modified with silver, zinc, copper, and/or antimony. The payment method can include radio-frequency identification, near field communication, a magnetic strip, a bar code, a QR code, profile containing or utilizing the same, or combinations thereof, and can be received by a payment method reader 30. The payment method can transmit payment. The payment method reader 30 can transmit unique, identifying information, such as a unique QR code, unique bar code, or unique information based on radio-frequency identification, near field communication, a magnetic strip, profile containing or utilizing the same, or combinations thereof In some embodiments, based on receipt of payment from the payment method, access can be provided to the animal cage 10 for the temporary storage of a domestic animal. Based on storage of the domestic animal, the door 20 can be shut and automatically, electronically locked by utilizing, for example, a bolt lock 26 that turns to enclose a door 20 upon receipt of an electronic signal based on receipt of the payment method. The animal can be removed based on receipt of the identical identifying information, which can come from a unique QR code, unique bar code, or unique information based on radio-frequency identification, near field communication, a magnetic strip, profile containing or utilizing the same, or combinations thereof. According to certain embodiments, the door 20 is hingedly attached to at least one of the top 12, bottom 22, side 16, and back walls 14.

According to certain embodiments, the animal cage 10 can include at least one removable pad 24, wherein the removable pad 24 comprises an absorbent acrylic acid derivative. In some embodiments, the space can include a plurality of removable pad 24s on an inner portion of the bottom surface, wherein the pads 24 are removably bound to one another with an adhesive, thereby enabling removal of an individual pad 24 after use.

In some embodiments, the door 20 is configured to be locked based on a payment from the payment method. Based on receipt of a payment method, a locking mechanism, such as a bolt lock configured to lock based on receipt of an electronic signal, can toggle its position between open / unlocked and closed/locked. The payment method can include radio-frequency identification, near field communication, a magnetic strip, a bar code, a QR code, profile containing or utilizing the same, or combinations thereof. The payment method can transmit payment. The payment method can transmit unique, identifying information, such as a unique QR code, unique bar code, or unique information based on radio-frequency identification, near field communication, a magnetic strip, profile containing or utilizing the same, or combinations thereof. According to certain embodiments, the at least one top wall 12, at least one bottom wall 22, at least one back wall 14, and at least two side walls 16 define a space therebetween. In some embodiments, the door 20 is configured to provide access to the space for removal of the domesticated animal based on identification, wherein the identification is based on the payment method.

According to certain embodiments, the at least one top wall 12, at least one bottom wall 22, at least one back wall 14, at least two side walls 16, and door 20 form a substantially rectangular cuboid, wherein the substantially rectangular cuboid is configured to be fit adjacent to a similar substantially rectangular cuboid. In some embodiments, the door 20, top, bottom, side, and back surfaces form a substantially rectangular cuboid. In some embodiments, the animal cage 10 is configured to be fit adjacent to a similar animal cage 10, which can be a substantially rectangular cuboid. The animal cage 10 can be configured to fit adjacent to a similar animal cage 10 by an attachment portion 32. The attachment portion 32 can be, for example, hook and loop fasteners, or friction fit with a coordinated groove and protrusion.

In some embodiments, the at least one top wall 12, at least one bottom wall 22, at least one back wall 14, at least two side wall 16s, and door 20 substantially enclose a space, wherein the space comprises a hygienic coating. The hygienic coating can be a porous coating on an inner surface of the walls. The hygienic coating can be a paint comprising a quaternary ammonium compound, such as alkyl dimethyl benzyl ammonium chloride. In some embodiments, the hygenic coating can be a porous paint comprising a quaternary ammonium compound, such as alkyl dimethyl benzyl ammonium chloride. According to certain embodiments, the at least one top wall 12, at least one bottom wall 22, at least one back wall 14, at least two side wall 16s, and door 20 substantially enclose a space, wherein the space comprises at least one temperature sensor, wherein the temperature sensor is operatively coupled to an air temperature control system. The temperature sensor can be operatively coupled to an air temperature control system. In some embodiments, the temperature sensor can be embedded in at least one of the walls. In some embodiments, the temperature sensor can be attached to an inner surface of at least one of the walls. In some embodiments, the temperature sensor can be a thermocouple 28.

### Embodiments

In a first embodiment, provided is a method of temporary storage of a domesticated animal, comprising: providing a space defined by a door and top, bottom, side, and back surfaces, wherein the door is configured to be opened based on identification based on a payment method.

The method of the first embodiment may further provide that the door is hingedly attached to at least one of the top, bottom, side, and back surfaces.

The method of the first or any subsequent embodiments may further provide that the space includes at least one removable pad, wherein the removable pad comprises an absorbent acrylic acid derivative.

The method of the first or any subsequent embodiments may further provide that the space comprises a plurality of removable pads on an inner portion of the bottom surface, wherein the plurality of removable pads are removably bound with an adhesive.

The method of the first or any subsequent embodiments may further provide that the method further comprises providing access to the space for the temporary storage of a domestic animal based on a receipt of payment.

The method of the first or any subsequent embodiments may further provide that the method further comprises providing access to the space for removal of the domesticated animal based on identification, wherein the identification is based on the payment method. The method of the first or any subsequent embodiments may further provide that the payment method includes at least one of radio-frequency identification, near field communication, or a magnetic strip.

The method of the first or any subsequent embodiments may further provide that the door, top, bottom, side, and back surfaces form a substantially rectangular cuboid, wherein the substantially rectangular cuboid is configured to be fit adjacent to a similar substantially rectangular cuboid.

The method of the first or any subsequent embodiments may further provide that the space comprises a hygienic coating.

The method of the first or any subsequent embodiments may further provide that the space comprises at least one temperature sensor, wherein the temperature sensor is operatively coupled to an air temperature control system.

In a second embodiment, provided is an animal cage, comprising at least one top wall, at least one bottom wall, at least one back wall, at least two side walls, and a door, wherein the door is hingedly attached to at least one of the at least one top surface, at least one bottom surface, one of the at least two side surfaces, and wherein the door is configured to be opened based on identification based on a payment method.

The animal cage of the second embodiment may further provide that the door is hingedly attached to at least one of the at least one top surface, the at least one bottom surface, one of the at least two side surfaces, or the back surface.

The second or any subsequent embodiments may further include at least one removable pad, wherein the removable pad comprises an absorbent acrylic acid derivative.

The second or any subsequent embodiments may further include a plurality of removable pads on an inner portion of the bottom surface, wherein the plurality of removable pads are removably bound with an adhesive.

The second or any subsequent embodiments may further provide that the door is configured to be locked based on a payment from the payment method.

The second or any subsequent embodiments may further provide that the at least one top wall, at least one bottom wall, at least one back wall, and at least two side walls define a space therebetween, wherein the payment method includes at least one of radio-frequency identification, near field communication, or a magnetic strip.

The second or any subsequent embodiments may further provide that the door is configured to provide access to the space for removal of the domesticated animal based on identification, wherein the identification is based on the payment method.

The second or any subsequent embodiments may further provide that the at least one top wall, at least one bottom wall, at least one back wall, at least two side walls, and door form a substantially rectangular cuboid, wherein the substantially rectangular cuboid is configured to be fit adjacent to a similar substantially rectangular cuboid.

The second or any subsequent embodiments may further provide that the at least one top wall, at least one bottom wall, at least one back wall, at least two side walls, and door substantially enclose a space, wherein the space comprises a hygienic coating.

The second or any subsequent embodiments may further provide that at least one top wall, at least one bottom wall, at least one back wall, at least two side walls, and door substantially enclose a space, wherein the space comprises at least one temperature sensor, wherein the temperature sensor is operatively coupled to an air temperature control system.

Additional aspects and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

I claim:

1. A method of temporary storage of a domesticated animal, comprising:
providing a space defined by a door and top, bottom, side, and back surfaces, wherein the door is configured to be opened based on identification based on a payment method.

2. The method of claim 1, wherein the door is hingedly attached to at least one of the top, bottom, side, and back surfaces.

3. The method of claim 1, wherein the space includes at least one removable pad, wherein the removable pad comprises an absorbent acrylic acid derivative.

4. The method of claim 3, wherein the space comprises a plurality of removable pads on an inner portion of the bottom surface, wherein the plurality of removable pads are removably bound with an adhesive.

5. The method of claim 1, further comprising providing access to the space for the temporary storage of a domestic animal based on a receipt of payment.

6. The method of claim 1, further comprising providing access to the space for removal of the domesticated animal based on identification, wherein the identification is based on the payment method.

7. The method of claim 1, wherein the payment method includes at least one of radio-frequency identification, near field communication, or a magnetic strip.

8. The method of claim 1, wherein the door, top, bottom, side, and back surfaces form a substantially rectangular cuboid, wherein the substantially rectangular cuboid is configured to be fit adjacent to a similar substantially rectangular cuboid.

9. The method of claim 1, wherein the space comprises a hygienic coating.

10. The method of claim 1, wherein the space comprises at least one temperature sensor, wherein the temperature sensor is operatively coupled to an air temperature control system.

11. An animal cage, comprising:
at least one top wall;
at least one bottom wall;
at least one back wall;
at least two side walls; and
a door, wherein the door is hingedly attached to at least one of the at least one top surface, at least one bottom surface, one of the at least two side surfaces, and wherein the door is configured to be opened based on identification based on a payment method.

12. The animal cage of claim 11, wherein the door is hingedly attached to at least one of the at least one top surface, the at least one bottom surface, one of the at least two side surfaces, or the back surface.

13. The animal cage of claim 11, further comprising at least one removable pad, wherein the removable pad comprises an absorbent acrylic acid derivative.

14. The animal cage of claim 13, wherein the animal cage comprises a plurality of removable pads on an inner portion of the bottom surface, wherein the plurality of removable pads are removably bound with an adhesive.

15. The animal cage of claim 11, wherein the door is configured to be locked based on a payment from the payment method.

16. The animal cage of claim 11, wherein the at least one top wall, at least one bottom wall, at least one back wall, and at least two side walls define a space therebetween, wherein the payment method includes at least one of radio-frequency identification, near field communication, or a magnetic strip.

17. The animal cage of claim 16, wherein the door is configured to provide access to the space for removal of the domesticated animal based on identification, wherein the identification is based on the payment method.

18. The animal cage of claim 11, wherein the at least one top wall, at least one bottom wall, at least one back wall, at least two side walls, and door form a substantially rectangular cuboid, wherein the substantially rectangular cuboid is configured to be fit adjacent to a similar substantially rectangular cuboid.

19. The animal cage of claim 11, wherein the at least one top wall, at least one bottom wall, at least one back wall, at least two side walls, and door substantially enclose a space, wherein the space comprises a hygienic coating.

20. The animal cage of claim 11, wherein the at least one top wall, at least one bottom wall, at least one back wall, at least two side walls, and door substantially enclose a space, wherein the space comprises at least one temperature sensor, wherein the temperature sensor is operatively coupled to an air temperature control system.
